(19) United States
(12) Patent Application Publication
(10) Pub. No.: US 2019/0392320 A1
(43) Pub. Date: Dec. 26, 2019

(54) BATTERY DEVICE AND CONTROLLING METHOD THEREOF

(71) Applicant: LG ELECTRONICS INC., Seoul (KR)

(72) Inventor: Wonchul Kim, Seoul (KR)

(73) Assignee: LG ELECTRONICS INC., Seoul (KR)

(21) Appl. No.: 16/563,001

(22) Filed: Sep. 6, 2019

(30) Foreign Application Priority Data
Aug. 9, 2019 (KR) 10-2019-0097512

(51) Int. Cl. G06N 3/08; B60L 58/12; G07C 5/08; H02J 7/00

(52) U.S. Cl. CPC G06N 3/08; B60L 58/12; G07C 5/0825; B60Y 2200/91; B60L 2240/545; B60L 2240/547; B60L 2240/549; H02J 7/0068

(57) ABSTRACT

A controlling method of a battery includes learning an artificial neural network to obtain first characteristic data inside the battery corresponding to first input and output data; collecting second input and output data for a period of time by charging or discharging the battery based on the obtained first characteristic data and user's usage environment information; updating a parameter of the artificial neural network based on the collected second input and output data; and learning the artificial neural network to obtain second characteristic data inside the battery corresponding to the collected second input and output data based on the updated parameter.

### BACKGROUND

Embodiments relate to a battery device and a controlling method thereof, and more particularly, to a battery device and a controlling method thereof capable of more accurately obtaining internal characteristics based on artificial intelligence.

Artificial intelligence is a field of computer engineering and information technology involving studying how computers can think, learn and self-develop in ways similar to human intelligence, and means that computers can emulate intelligent actions of humans.

In addition, artificial intelligence does not exist by itself but is directly or indirectly associated with the other fields of computer science. In particular, many attempts have been made to introduce elements of artificial intelligence into various fields of information technology.

Meanwhile, batteries have been used in a wide range of fields such as electric vehicles, mobile terminals, etc.

A secondary battery includes various materials formed therein and performs charging or discharging according to an electrochemical reaction inside a battery.

Meanwhile, in optimal control of input/output of the battery, the characteristic parameter indicating the state of the internal material of the battery may be used as useful data.

For example, if the characteristic parameter is first grasped, the internal state of the battery such as the capacity of the battery, the state of charge of the battery or the lifespan of the battery can be accurately grasped. In addition, it is possible to perform optimal charge/discharge control, such as calculation of a charging current value capable of maximizing a charge rate while minimally affecting the lifespan of the battery, according to the internal state of the battery.

Meanwhile, the characteristic parameter and the internal state of the battery when the battery is first installed may be grasped based on the specifications of the battery designed by a battery manufacturer.

However, the characteristic parameter is changed while the battery is used, thereby changing the internal state of the battery. In addition, once the battery is installed in a product, it is impossible to grasp the characteristic parameter and the internal state of the battery unless the battery is destroyed.

Accordingly, conventionally, a method of indirectly inferring the internal state of the battery using the specifications of the battery designed by the battery manufacturer and the number of times of charging the battery was used.

Since this method has large error, it is impossible to perform optimal battery control using the accurate internal state of the battery.

In addition, since control was performed in consideration of maximum error for stability of the battery, it is impossible to maximize the performance of the battery.

### SUMMARY

An object of the embodiment is to solve the above and other problems.

Another object of the embodiment is to provide a battery device and a controlling method thereof capable of optimally controlling by more accurately obtaining the internal characteristics based on artificial intelligence.

According to an aspect of an embodiment to achieve the above or another object, a controlling method of a battery, comprising: learning a Gaussian process neural network to obtain first characteristic data inside the battery corresponding to first input and output data; collecting second input and output data for a period of time by charging or discharging the battery based on the obtained first characteristic data and user's usage environment information; updating a parameter of the Gaussian process neural network based on the collected second input and output data; and learning the Gaussian process neural network to obtain second characteristic data inside the battery corresponding to the collected second input and output data based on the updated parameter.

According to another aspect of an embodiment, a battery device includes a battery; a collecting unit collecting input and output data of the battery; a Gaussian process neural network; and a controller. The controller controls to learn the Gaussian process neural network to obtain first characteristic data inside the battery corresponding to first input and output data, controls the collecting unit so as to collect the second input and output data for a period of time by charging or discharging the battery based on the obtained first characteristic data and user's usage environment information, and controls to learn the Gaussian process neural network so as to update a parameter of the Gaussian process neural network based on the collected second input and output data, and to obtain second characteristic data inside the battery corresponding to the collected second input and output data.

The effects of the battery device and the controlling method thereof according to the embodiment will be described below.

According to at least one of the embodiments, more accurate characteristic data reflecting even user's usage pattern can be obtained by obtaining the characteristic data inside the battery based on the input and output data reflecting the user's usage environment in addition to obtaining the characteristic data inside the battery simply based on the training data. By controlling to charge or discharge the battery based on the more accurate characteristic data inside the battery as described above, optimum battery control is possible. Optimum battery control can extend the life of the battery and it can accurately tell the time to charge the battery.

### BRIEF DESCRIPTION OF THE DRAWING

FIG. 1 is a block diagram illustrating a battery device according to an embodiment of the present invention.

FIG. 2 is diagrams illustrating a method of training an artificial neural network according to an embodiment of the present invention.

FIG. 3 is a view schematically illustrating a learning method of a battery device according to an embodiment of the present invention.

FIG. 4 is a block diagram illustrating a mobile terminal according to the present invention.

FIG. 5 is a schematic block diagram illustrating the internal configuration of an electric vehicle.

FIG. 6 is a flowchart illustrating a method of controlling a battery device according to an embodiment of the present invention.

FIG. 7 is a first flowchart illustrating S520 in detail in a controlling method of a battery device according to an embodiment of the present invention.

FIG. 8 is a second flowchart illustrating S520 in detail in a controlling method of a battery device according to an embodiment of the present invention.

FIG. 9 is a view schematically illustrating a controlling method of a battery device according to an embodiment of the present invention.

FIG. 10 is a third flowchart illustrating S520 in detail in a controlling method of a battery device according to an embodiment of the present invention.

FIG. 11 is a diagram for describing an operation in a control option providing mode.

### DETAILED DESCRIPTION OF THE EMBODIMENTS

Hereinafter, embodiments disclosed herein will be described in detail with reference to the accompanying drawings, and the same or similar components will be given the same reference numerals regardless of the reference numerals, and redundant description thereof will be omitted. The suffixes “module” and “unit” for components used in the following description are given or used interchangeably in consideration of only ease of specification writing and do not have distinct meanings or roles from each other. In addition, in describing the embodiments disclosed herein, in a case where it is determined that the detailed description of the related known technology may obscure the gist of the embodiments disclosed herein, the detailed description thereof will be omitted. In addition, it should be understood that the accompanying drawings are only for easily understanding the embodiments disclosed herein, the technical spirit disclosed in the specification by the accompanying drawings are not limited, and all changes, equivalents, and substitutes included in the spirit and scope of the present invention are included therein.

Terms including ordinal numbers such as first and second may be used to describe various components, but the components are not limited by the terms. The terms are used only for the purpose of distinguishing one component from another.

When a component is referred to as being “connected” or “attached” to another component, the component may be directly connected to or attached to the other component, but it may be understood that other components may be present therebetween. On the other hand, when a component is said to be “directly connected” or “directly attached” to the other component, it should be understood that there is no other component therebetween.

Singular expressions include plural expressions unless the context clearly indicates otherwise. In this application, It is to be understood that the terms “comprises” or “having” are intended to indicate that there is a feature, number, step, operation, component, part, or combination thereof described in the specification, and the present invention does not exclude the possibility of the presence or the addition of one or more other features, numbers, steps, operations, components, components, or a combination thereof.

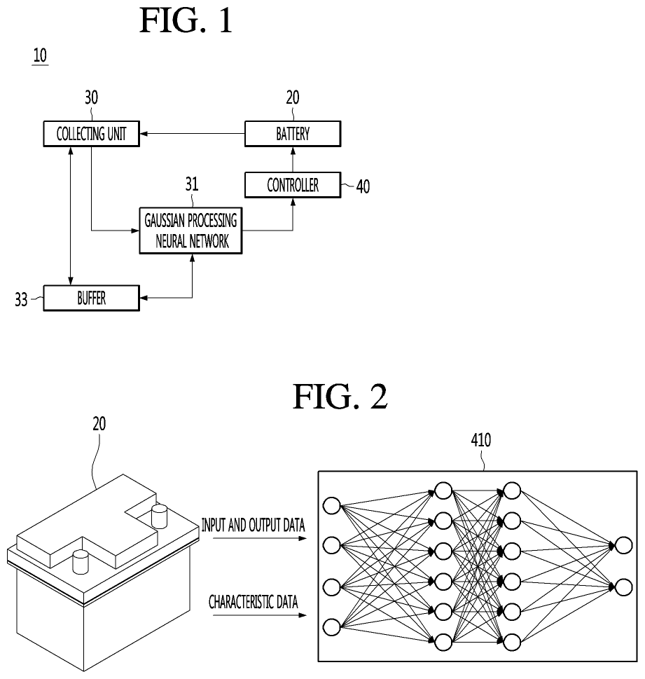

FIG. 1 is a block diagram illustrating a battery device according to an embodiment of the present invention.

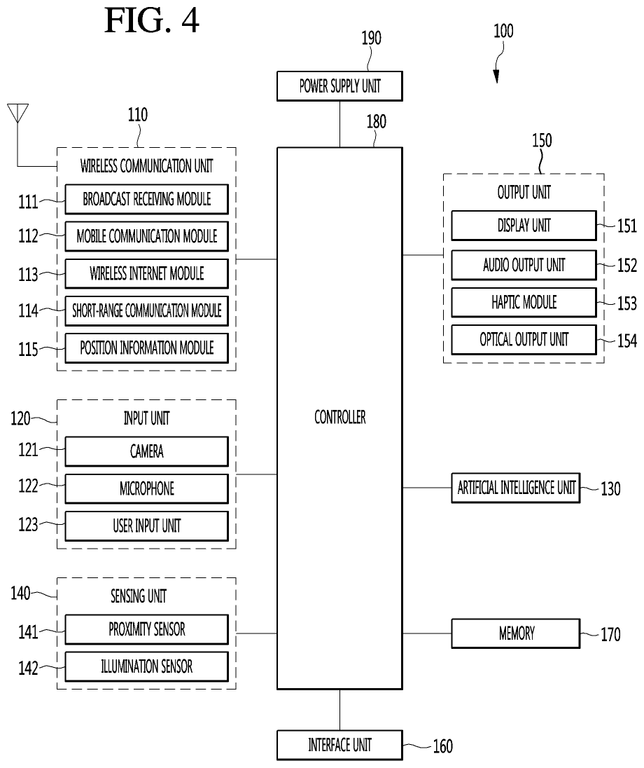

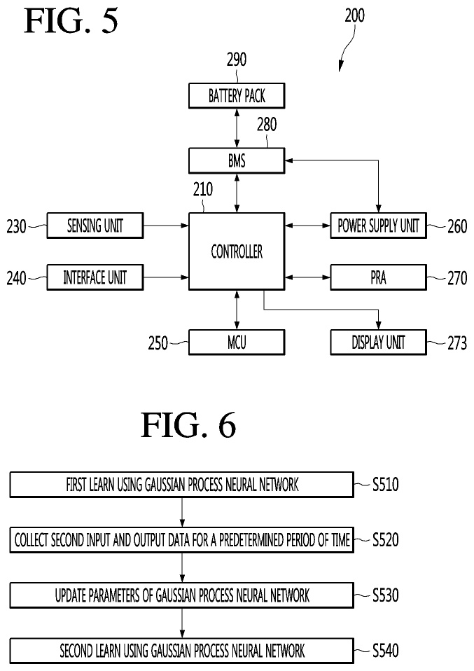

Referring to FIG. 1, a battery device 10 according to an embodiment of the present invention may include a battery 20, a collecting unit 30, a Gaussian process neural network (GPN) 31, a buffer 33, and a controller 40. The battery device 10 according to the embodiment of the present invention is not limited thereto and may include fewer components or more components. The controller 40 may be the controller 180 illustrated in FIG. 4 or the controller 210 illustrated in FIG. 5.

The battery 20 may be a device which is composed of positive and negative electrolytic solutions and may be used as a power source by generating current electromotive force by a chemical action.

The battery 20 may be discharged. Specifically, the battery 20 may supply power to the components included in the device 10 including the battery under control of the controller 40.

The battery 20 may be charged. Specifically, the device 10 including the battery may include a charging port (not illustrated), and the battery 20 may be connected to the charging port (not illustrated). In addition, the battery 20 may receive electric energy from the outside through the charging port (not illustrated) and perform charging, under control of controller 40.

Meanwhile, the device 10 including the battery may include a charging/discharging control circuit (not illustrated) for controlling charging or discharging of the battery 20, under control of the controller 40.

In this case, the charging/discharging control circuit (not illustrated) may control charging voltage or charging current at the time of charging or control discharging voltage or discharging current at the time of discharging the battery 20, under control of the controller 40.

The collecting unit 30 may detect input and output data of the battery 20. The input and output data of the battery 20 is data which can be measured from the outside of the battery 20 and may include at least one of voltage, current, temperature, and state of charge (SOC). The voltage may be an input voltage to the battery 20 or an output voltage of the battery 20. The current may be an input current or an output current of the battery 20. The temperature may be the temperature of the battery 20. The state of charge may mean the amount of power currently remaining in the battery since the battery 20 is discharged.

The Gaussian process neural network 31 may be a Gaussian treated regression neural network. Gaussian process is a type of supervised learning. The Gaussian process can train with labeled data, and estimate the output corresponding to that data as new data is input. However, in the Gaussian process, since the learning is performed based on two parameter values, that is, an average value and a variance value, computation may be very simple. The Gaussian process is well known and further detailed descriptions will be omitted.

The Gaussian process neural network 31 may input the input and output data collected by the collecting unit 30 to obtain an output value corresponding to the input and output data, that is, characteristic data inside the battery 20. The characteristic data inside the battery 20 is data representing material characteristics inside the battery 20 and may include, for example, conductivity. Material characteristics inside the battery 20 will be described later in detail.

The Gaussian process neural network 31 may obtain characteristic data inside the battery 20 based on the training data. In addition, the Gaussian process neural network 31 may obtain characteristic data inside the battery 20 based on input and output data reflecting a user's usage environment. The user's usage environment indicates a usage pattern and may be a driving habit of the user. For example, a user may frequently apply rapid acceleration and sudden brake, frequently drive high speed or turn on an air conditioner or a heater frequently. In other words, even if the battery 20 of the same capacity is used according to the user or the user's driving habits, the characteristic data inside the battery 20 or the state of charge of the battery 20 may be different.

The buffer 33 may store input and output data collected by the collecting unit 30 or characteristic data inside the battery 20 obtained by the Gaussian process neural network 31. The buffer 33 may be used interchangeably as a memory or a storage unit.

According to an embodiment of the present invention, by obtaining the characteristic data inside the battery 20 based on the input and output reflecting the user's usage environment in addition to obtaining of the characteristic data inside the battery 20 simply based on the training data, the more accurate characteristic data reflecting even the user's usage pattern may be obtained. As such, the battery 20 may be optimally controlled by controlling the battery 20 to be charged or discharged based on more accurate characteristic data inside the battery 20. Optimum control of the battery 20 can extend the life of the battery 20, it can accurately tell the time to charge the battery 20.

The controller 40 may control overall operation of the device including the battery.

Specifically, the controller 40 may control charging of the battery. Controlling charging of the battery means controlling the charging/discharging control circuit (not illustrated) to control a charging voltage or charging current at the time of charging the battery 20.

The controller 40 may control discharging of the battery. Controlling discharging of the battery means controlling the charging/discharging control circuit (not illustrated) to control a discharging voltage or discharging current at the time of discharging the battery 20.

The controller 40 may operate the components in the device 10 including the battery using the discharged current.

The controller 40 may control to charge or discharge the battery 20 based on the characteristic data inside the battery 20 obtained from the Gaussian process neural network 31. In detail, the user may refer to the characteristic data of the battery 20 while driving. For example, in a case where the characteristic data of the battery 20 indicates that the state of charge of the battery 20 is lack and thus the battery should be charged, the battery 20 may be charged at the charging station. For example, in a case where the characteristic data of the battery 20 indicates that the state of charge of the battery 20 is too much and driving is possible, the driving may be performed to reach a user's destination.

The characteristic data inside the battery 20 obtained from the Gaussian process neural network 31 according to the driver's usage environment, that is, the usage pattern or driving habits, is different from the characteristic data inside the battery 20 obtained from the Gaussian process neural network 31 using training data. In other words, in the related art, in the characteristic data inside the battery 20 obtained from the Gaussian process neural network 31 using the training data, the user's usage environment is not considered, so that the accuracy of the characteristic data inside the obtained battery 20 may be deteriorated. On the contrary, as in the embodiment of the present invention, the characteristic data inside the battery 20 obtained in consideration of the user's usage environment may be significantly improved in accuracy.

In the present invention, the characteristic data inside the battery 20 is simply obtained by using simply the training data and in addition, the mobile terminal 100 or the electric vehicle 200 is used according to a user's usage environment, the battery 20 is charged or discharged, and then the characteristic data inside the battery 20 is obtained, so that the accuracy of the characteristic data inside the battery 20 is increased, thereby enabling optimal control.

FIG. 2 is a view for explaining a method for learning an artificial neural network in a battery device according to an embodiment of the present invention.

The ANN 410 is a statistical learning algorithm inspired by the biological neural networks in machine learning and cognitive science. Artificial neurons (nodes) forming a network by connecting synapses change the strength of connection of the synapses through learning to have a problem solution ability.

The artificial neural network (ANN) may include a Gaussian process neural network (31 in FIG. 1). The Gaussian process neural network 31 may include a Gaussian process regression neural network.

The Gaussian process neural network 31 may be trained to obtain characteristic data corresponding to the detected input and output data using the training data. The training data may include input and output data and characteristic data corresponding to the input and output data. The training data can be databased into a dataset in advance, for example, by the battery manufacturer. The Gaussian process neural network 31 can input the input and output data and the characteristic data corresponding to the input and output data as the training data, and learn the input and output data which is input and the characteristic data corresponding to the input and output data according to the Gaussian control function, and obtain the characteristic data inside the battery 20. The Gaussian control function may be a function that takes an average value and a variance value as parameters. If the average value or the variance value is different, the Gaussian control function is also different, and the characteristic data inside the battery 20 obtained by learning according to the changed Gaussian control function may also be different.

The characteristic parameter may be a parameter indicating the state of the internal material of the battery.

Specifically, the characteristic parameter may include at least one of effective conductivity σ_{eff}, electronic conductivity σ+, solid diffusivity Ds+ and Ds−, a reaction rate constant of exchange current K+ and K−, tortuosity τ−, porosity ε−, electrolyte concentration Ce, electrolyte conductivity Ke_scale, electrolyte diffusivity De_scale, a ratio of cations in conductivity of cations and anions (transference number t0+), a degree of shift as the capacity of a positive electrode/negative electrode is degraded (Qshift) and a degree of reduction in capacity of the positive electrode/negative electrode (Qscale+, Qscale−).

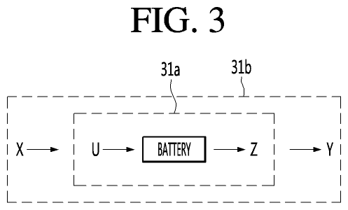

FIG. 3 is a view schematically illustrating a learning method of a battery device according to an embodiment of the present invention.

As illustrated in FIG. 3, the Gaussian process neural network 31 may include a first Gaussian process neural network 31a which learns to obtain characteristic data inside the battery 20 using training data. The first Gaussian process neural network 31a may obtain first characteristic data Z based on the first input and output data U. The training data is data obtained in advance for providing to the first Gaussian process neural network 31a and may include first input and output data U and first characteristic data Z. The first characteristic data Z may correspond to the first input and output data U but is not limited thereto.

The first input and output data U may include at least one of voltage, current, and temperature. The first input and output data U may include a state of charge. This state of charge is provided to the first Gaussian process neural network 31a along with at least one of other input and output data, that is, voltage, current, and temperature, to be learned, so that the first characteristic data Z can be obtained.

The first characteristic data Z may include for example, at least one of electron conductivity, solid diffusion rate, reaction rate constant of exchange current, torsion degree, porosity, electrolyte concentration, electrolyte conductivity, electrolyte diffusion coefficient, ratio of cation in cation and anion conductivity, the degree of misalignment as the capacity of the positive electrode and the negative electrode degenerates, and the degree of decrease in the capacity of the positive electrode and the negative electrode. Such first characteristic data Z may be provided to the first Gaussian process neural network 31 as the first input and output data U.

The first characteristic data Z may include, for example, a state of charge. In other words, the first Gaussian process neural network 31a may obtain a state of charge based on the first input and output data U. Alternatively, the state of charge may be obtained based on the characteristic data such as the electronic conductivity described above.

Meanwhile, the first input and output data U may include characteristic data such as electronic conductivity. In other words, such characteristic data may be provided to the first Gaussian process neural network 31a together with at least one of voltage, current, and temperature. In addition to the characteristic data, the first Gaussian process neural network 31a may learn to obtain characteristic data corresponding to at least one of voltage, current, and temperature. The characteristic data obtained in the first Gaussian process neural network 31a may be upgraded from the characteristic data provided in the first Gaussian process neural network 31a. In other words, upgraded feature data can be predicted or followed more accurately.

The Gaussian process neural network 31 may include a second Gaussian process neural network 31b which learns to obtain characteristic data inside the battery 20 based on input and output data reflecting a user's usage environment. The second Gaussian process neural network 31b may obtain second characteristic data Y based on the second input and output data X.

The second input and output data X may be obtained by directly measuring the battery 20. The second input and output data X may be the same as the first input and output data U. In other words, the second input and output data X may include at least one of voltage, current, and temperature.

The second input and output data X may be data reflecting a user's environment. The user's usage environment may include at least one of a driving distance per driving, whether to drive at a high speed, an amount of electricity used per hour, and frequency in use of air conditioner or heater. As the vehicle is driven by the user's usage environment, the second input and output data X measured by the battery 20 may be different from the first input and output data U. The second Gaussian process neural network 31b may update the parameters of the second Gaussian process neural network 31b based on the second input and output data X.

Accordingly, the second Gaussian process neural network 31b obtains the second characteristic data Y corresponding to the second input and output data X reflecting the user's usage environment, and thus the obtained second input and output data X can be predicted or followed more accurately.

Meanwhile, the first Gaussian process neural network 31a and the second Gaussian process neural network 31b may be the same. However, while the first Gaussian process neural network 31a receives the first input and output data U as training data, the second Gaussian process neural network 31b can receive the second input and output data X reflecting the user's usage environment.

Meanwhile, FIGS. 4 and 5 illustrate the mobile terminal 100 and the electric vehicle 200 as examples of the battery device 10. However, the present invention is not limited thereto, and the present invention may be applied to any device including the battery 20 and performing charge and discharge.

FIG. 4 is a block diagram illustrating a mobile terminal according to the present invention.

The mobile terminal 100 is illustrated having components such as a wireless communication unit 110, an input unit 120, an artificial intelligence unit 130, a sensing unit 140, an output unit 150, an interface unit 160, a memory 170, a controller 180, and a power supply unit 190.

The sensing unit 140 may be used interchangeably with the collecting unit 30 illustrated in FIG. 1.

It is understood that implementing all of the illustrated components is not a requirement, and that greater or fewer components may alternatively be implemented. Specifically, the wireless communication unit 110 typically includes one or more components which permit wireless communication between the mobile terminal 100 and a wireless communication system or network within which the mobile terminal is located. The wireless communication unit 110 includes one or more of a broadcast receiving module 111, a mobile communication module 112, a wireless Internet module 113, a short-range communication module 114, and a position information module 115. The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

An artificial intelligence unit 130 is responsible for processing information based on artificial intelligence technology and may include one or more modules for performing at least one of learning of information, inference of information, perception of information and processing of a natural language.

The artificial intelligence unit 130 may perform at least one of learning, inference and processing of vast amounts of information (big data) such as information stored in the mobile terminal, surrounding environmental information of the mobile terminal and information stored in a communicable external storage. In addition, the artificial intelligence unit 130 may control the mobile terminal to predict (infer) executable operation of at least one mobile terminal and to perform most feasible operation of the at least one predicted operation, using the information learned using the machine learning technology.

The machine learning technology refers to technology of collecting and learning a large amount of information based on at least one algorithm and determining and predicting information based on the learned information. Learning of information refers to operation for grasping the characteristics, rules and criteria of judgement of the information, quantifying a relationship between information and information, and predicting new data using a quantified pattern.

An algorithm used by such machine learning technology may be a statistical based algorithm and may include, for example, a decision tree using a tree structure as a prediction model, an artificial neural network for emulating the neural network structure and function of an organism, genetic programing based on biological evolutionary algorithms, clustering for distributing observed examples into subsets such clusters, and a Monte-Carlo method of calculating the probability of a function value through a randomly extracted number.

As a field of machine learning technology, deep learning technology refers to technology of performing at least one of learning, determining and processing of information using an artificial neural network algorithm. The artificial neural network may have a structure for connecting a layer and a layer and transmitting data between the layer and the layer. Such deep learning technology may learn vast amounts of information through an artificial neural network using a graphic processing unit (GPU) optimized for parallel computation.

Meanwhile, the artificial intelligence unit 130 may collect (sense, monitor, extract, detect or receive) signals, data, information, etc. input to or output from the components of the mobile terminal in order to collect vast amounts of information for applying machine learning technology. In addition, the artificial intelligence unit 130 may collect (sense, monitor, extract, detect or receive) data, information, etc. stored in an external storage (e.g., a cloud server) connected through communication. More specifically, collection of information may be understood as the term including sensing of information through a sensor, extraction of information stored in the memory 170, or reception of information from the external storage through communication.

The artificial intelligence unit 130 may sense information in the mobile terminal, surrounding environment information of the mobile terminal and user information through the sensing unit 140. In addition, the artificial intelligence unit 130 may receive a broadcast signal and/or broadcast related information, wireless signal, wireless data, etc. through the wireless communication unit 110. In addition, the artificial intelligence unit 130 may receive image information (or signal), audio information (or signal), data or information input by a user from the input unit.

Such an artificial intelligence unit 130 may collect vast amounts of information in real time in the background and learn the information, and store information processed in an appropriate form (e.g. knowledge graph, command policy, personalization database, dialog engine, etc.) in the memory 170.

In addition, when operation of the mobile terminal is predicted based on the information learned using the machine learning technology, the artificial intelligence unit 130 may control the components of the mobile terminal and send a control command for executing the predicted operation to the controller 180, in order to execute the predicted operation. The controller 180 may control the mobile terminal based on the control command to execute the predicted operation.

Meanwhile, when specific operation is performed, the artificial intelligence unit 130 may analyze history information indicating performing of the specific operation through machine learning technology and update existing learned information based on the analyzed information. Therefore, the artificial intelligence unit 130 may improve information prediction accuracy.

Meanwhile, in this specification, the artificial intelligence unit 130 and the controller 180 may be understood as the same component. In this case, the function performed by the controller 180 described in this specification may be described as being performed by the artificial intelligence unit 130, and the controller 180 may be referred to as the artificial intelligence unit 130 or the artificial intelligence unit 130 may be referred to as the controller 180.

Alternatively, in this specification, the artificial intelligence unit 130 and the controller 180 may be understood as different components. In this case, the artificial intelligence unit 130 and the controller 180 may perform a variety of control on the mobile terminal through data exchange. The controller 180 may perform at least one function on the mobile terminal based on a result derived from the artificial intelligence unit 130 or control at least one of the components of the mobile terminal. Further, the artificial intelligence unit 130 may operate under control of the controller 180.

The sensing unit 140 is typically implemented using one or more sensors configured to sense internal information of the mobile terminal, the surrounding environment of the mobile terminal, user information, and the like. For example, in FIG. 2, the sensing unit 140 is illustrated having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is illustrated having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 2, or activating application programs stored in the memory 170. As one example, the controller 180 controls some or all of the components illustrated in FIG. 2 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 4, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be a server which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module 113 may be internally or externally coupled to the mobile terminal 100. Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well. In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The position information module 115 is generally configured to detect, calculate, derive or otherwise identify a position of the mobile terminal. As an example, the position information module 115 includes a Global Position System (GPS) module, a Wi-Fi module, or both. If desired, the position information module 115 may alternatively or additionally function with any of the other modules of the wireless communication unit 110 to obtain data related to the position of the mobile terminal.

As one example, when the mobile terminal uses a GPS module, a position of the mobile terminal may be obtained using a signal sent from a GPS satellite. As another example, when the mobile terminal uses the Wi-Fi module, a position of the mobile terminal can be obtained based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to obtain left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

For example, the display unit 151 may display the state of charge of the battery 20 and the corresponding information. The correspondence information may include, for example, air conditioner driving time adjustment information, control request information for high speed driving, and the like. In this case, the controller 180 may control to charge or discharge the battery 20 according to a command which responds to the corresponding information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Meanwhile, the battery device 10 may include the components of the mobile terminal 100 described with reference to FIG. 4 and may perform a function performed by the components of the mobile terminal 100.

FIG. 5 is a schematic block diagram showing the internal configuration of an electric vehicle.

Referring to FIG. 3, the electric vehicle 200 according to the present invention may include a controller 210, a sensing unit 230, an interface 240, a motor controller (MCU) 250, a power supply 260, a power relay assembly (PRA) 270, a battery management system (BMS) 280 and a battery pack 290.

The sensor unit 230 may be used interchangeably with the collecting unit 30 illustrated in FIG. 1.

The electric vehicle 200 includes the battery pack 290 including at least one battery, and receives power from the outside in a predetermined charging station or a vehicle charging facility or a home and charge the battery pack 290.

The BMS 280 determines the remaining capacity of the battery pack 290 and whether charging is necessary and performs management in supply of the charging current stored in the battery to the components of the electric vehicle.

At this time, when the battery is charged and used, the BMS 280 uniformly maintains a voltage difference between the cells in the battery and performs control to prevent the battery from being overcharged or over-discharged, thereby increasing the lifespan of the battery.

In addition, the BMS 280 includes a protection circuit for protecting supplied current such that the vehicle is driven for a long time through current management.

The battery pack 290 includes a plurality of batteries and stores electric energy with a high voltage.

The power supply 260 includes a connection terminal or a connection circuit for connection with a charging station, and applies charging current to the battery pack 290 under control of the BMS 280 to charge the battery when an external power supply is connected. In addition, the power supply 260 may change power stored in the battery pack 290 to power which may be used in each component and supply the changed power.

The sensing unit 230 senses a signal generated while the vehicle is driven or while predetermined operation is performed, and inputs the signal to the controller 210.

The sensing unit 230 includes a plurality of sensors inside and outside the vehicle and inputs various sensing signals. The type of the sensor may be changed depending on the installed position.

The display unit 273 may display vehicle related information or various contents.

For example, the display unit 273 may display the state of charge of the battery 20 and the corresponding information. The correspondence information may include, for example, air conditioner driving time adjustment information, control request information for high speed driving, and the like. In this case, the controller 210 may control to charge or discharge the battery 20 according to a command which responds to the corresponding information.

The interface 240 includes input means for inputting a predetermined signal by operation of a driver, output means for outputting information during the current state operation of the electric vehicle, and operation means operated by the driver to control the vehicle. At this time, the output means includes a display unit for displaying information, a speaker for outputting music, effect sound and warning sound, and various states. In addition, the input means includes a plurality of switches, buttons, etc. for operation of a turn signal lamp, a tail lamp, a head lamp, a brush, etc. while the vehicle is driven.

In addition, the interface 240 includes operation means for operation of a steering wheel, an accelerator and a brake.

The MCU 250 generates a control signal for driving at least one connected motor and generates and applies a predetermined signal for motor control. In addition, the MCU 250 changes high-voltage power according to the characteristics of the motor and supplies the changed power.

The PRA 270 includes a plurality of relays for switching a high voltage and a sensor and applies or blocks the high-voltage power received from the battery pack 290 to a specific position. In particular, the PRA 270 sequentially controls the relays not to suddenly supply the high-voltage power at the time of starting the vehicle, thereby stably supplying power to the vehicle.

The controller 210 performs control to generate and apply a predetermined command to perform predetermined operation in correspondence with input of the interface 240 and the sensing unit 230 and controls input/output of data to display the operation state of the electric vehicle.

In addition, the controller 210 manages the battery pack 290 through the BMS 280, applies a switching signal to the PRA 270 to control startup of the vehicle, and controls power supply to a specific position (part).

Meanwhile, the device 10 including the battery may include the components of the electric vehicle 200 described with reference to FIG. 3 and perform the functions performed by the components of the electric vehicle 200.

As illustrated above, the controller 40 of FIG. 1, the controller 180 of FIG. 4, and the controller 210 of FIG. 5 are the same. In the following description, the controller is limited to the controller 40 of FIG. 1, but the controller 180 of FIG. 4 and the controller 210 of FIG. 5 may be also equally applied.

FIG. 6 is a flowchart illustrating a controlling method of a battery device according to an embodiment of the present invention.

Referring to FIGS. 1 and 6, the battery device 10 according to an embodiment of the present invention may first learn using the Gaussian process neural network 31 (S510). In other words, the Gaussian process neural network 31 may learn to obtain first characteristic data Z inside the battery 20 corresponding to the first input and output data U which is training data. For example, the training data may be provided by a battery manufacturer but is not limited thereto. The training data may include first input and output data U and first characteristic data Z. The Gaussian process neural network 31 may self-learn the training data to obtain first characteristic data Z corresponding to the first input and output data U. The Gaussian process neural network 31 may be a kind of supervised learning neural network. In a case where the input and output of the Gaussian process neural network 31 are learned to be patterned and the first input and output data U is input, the first characteristic data Z may be output as the correct answer.

If the training data is not provided by the battery manufacturer, the input and output data is collected in the battery device 10 according to the embodiment of the present invention, and the Gaussian process neural network 31 may convert the collected input and output data into the first input and output data U and obtain the first characteristic data Z corresponding to the first input and output data U.

The battery device 10 according to the exemplary embodiment of the present invention, specifically, the collecting unit 30 may collect the second input and output data X for a predetermined period of time (S520). The period of time may include, for example, at least one of 1 hour, 1 day, 1 week, 1 month, half-year, and 1 year.

The second input and output data X may be collected by charging or discharging the battery 20 based on the obtained first characteristic data Z and user's usage environment information. The usage environment information may include at least one of, for example, a driving distance per driving, whether to drive at a high speed, an amount of electricity used per hour, and frequency in use of air conditioner or heater. In addition, all conditions or information which may be included in the user's usage environment may also be included in the usage environment information described in the present invention.

The user may use the battery device 10, for example, the mobile terminal (FIG. 4) or drive the electric vehicle (FIG. 5) by referring to the first characteristic data Z inside the battery 20. At this time, the user may reflect the usage environment so that the mobile terminal may be used or the electric vehicle may travel. The result reflecting the use environment of the user may be included in the second input and output data X collected by the collecting unit 30. In other words, the second input and output data X may vary according to the user's usage environment.

The battery device 10 according to the embodiment of the present invention may update the parameters of the Gaussian process neural network 31 (S530). For example, the controller 40 may update the parameters of the Gaussian process neural network 31 based on the second input and output data X collected by the collecting unit 30. The parameter may include an average value and a variance value. For example, the average value can be updated. For example, the variance value can be updated. For example, the average and variance values can be updated.

The battery device 10 according to an embodiment of the present invention may second learn using the Gaussian process neural network 31 (S540). In other words, the Gaussian process neural network 31 may learn to obtain second characteristic data Y inside the battery 20 corresponding to the second input and output data X based on the updated parameter.

According to an embodiment of the present invention, the obtained second characteristic data Y can be predicted more accurately and be followed by updating a parameter of the Gaussian process neural network 31 based on the second input and output data X reflecting the user's usage environment in addition to obtaining a characteristic data inside the battery using simply training data and newly obtaining the characteristic data inside the battery 20, that is, the second characteristic data Y based on the updated parameter. As such, the battery 20 may be optimally controlled by charging or discharging the battery 20 based on the second characteristic data Y inside the battery 20 more accurate. Optimum control of the battery 20 can extend the life of the battery 20, and it can accurately tell the time to charge the battery 20.

Meanwhile, S520 to S540 may be repeatedly performed. In other words, in S540, the target is driven based on the second characteristic data Y and the user's usage environment to charge or discharge the battery 20, so that the second input and output data X may be obtained. After the parameters of the Gaussian process neural network 31 are updated based on the obtained second input and output data X, second characteristic data Y corresponding to the second input and output data X can be obtained based on the updated parameters. Such an operation may be performed whenever the user operates an object or a target. Such an operation may be performed at, for example, one week, one month, half-year, or one year.

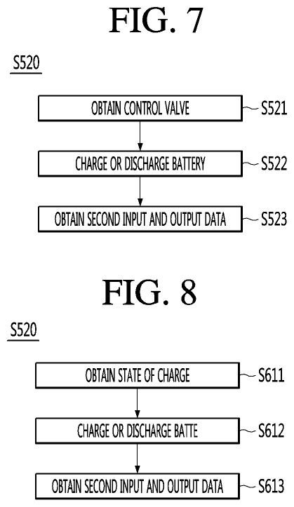

In the following FIGS. 7, 8, and 10, the method (S520) for collecting the second input and output data X in FIG. 6 is illustrated in detail. FIG. 7 is a first flowchart illustrating S520 in detail in a controlling method of a battery device 10 according to an embodiment of the present invention.

As illustrated in FIG. 7, the battery device 10 according to the embodiment of the present invention may obtain a control value (S521). In other words, the controller 40 may obtain a control value based on the first characteristic data Z and the usage environment information obtained by the Gaussian process neural network 31. The control value may be an object or a target, for example, any data or signal capable of operating the mobile terminal 100 of FIG. 4 or controlling the electric vehicle 200 of FIG. 5. Control values may be obtained using model predictive control (MPC), but are not limited thereto. MPC will be described later in detail.

The battery device 10 according to the embodiment of the present invention may charge or discharge the battery 20 (S522). In other words, the controller 40 may control to operate an object or a target according to the control value. As the object is operated as described above, the battery 20 may be charged or discharged.

The battery device 10 according to the embodiment of the present invention may obtain the second input and output data X (S523). In other words, the collecting unit 30 may collect the second input and output data X during or after the operation of the object or the target.

FIG. 8 is a second flowchart illustrating S520 in detail in a controlling method of a battery device according to an embodiment of the present invention.

As illustrated in FIG. 8, the battery device 10 according to the embodiment of the present invention may obtain a state of charge (S611). In other words, the controller 40 may obtain the state of charge based on the first characteristic data Z obtained by the Gaussian process neural network 31. As described above, the first characteristic data Z is, for example, at least one of electron conductivity, solid diffusion rate, reaction rate constant of exchange current, torsion degree, porosity, electrolyte concentration, electrolyte conductivity, electrolyte diffusion coefficient, ratio of cation in cation and anion conductivity, the degree of misalignment as the capacity of the positive electrode and the negative electrode degenerates, and the degree of decrease in the capacity of the positive electrode and the negative electrode. The controller 40 may calculate the state of charge of the inside of the battery 20 based on the first characteristic data Z, such as electronic conductivity.

The battery device 10 according to the embodiment of the present invention may charge or discharge the battery 20 (S612). In other words, the controller 40 may obtain a control value based on the state of charge and the usage environment information, and operate the object according to the obtained control value to charge or discharge the battery 20.

The battery device 10 according to an embodiment of the present invention may obtain second input and output data X (S613). Since S613 is the same as S523 illustrated in FIG. 7, a detailed description thereof will be omitted.

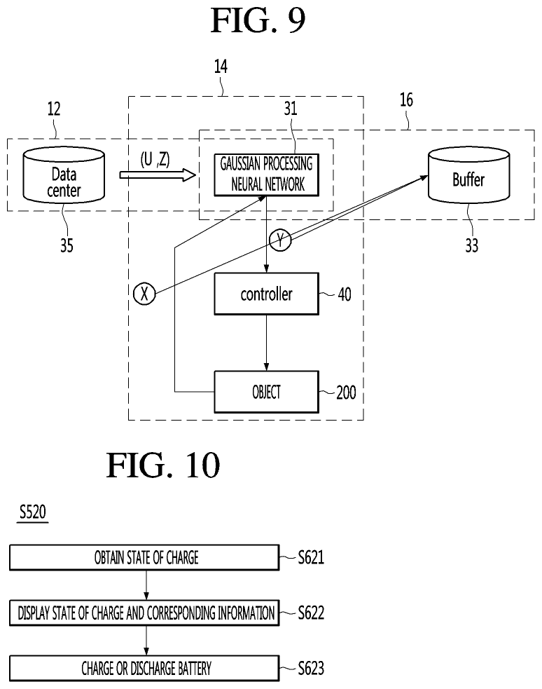

Referring to FIG. 9, a controlling method of a battery device according to an embodiment of the present invention will be described in detail.

FIG. 9 is a view schematically illustrating a controlling method of a battery device according to an embodiment of the present invention.

Referring to FIG. 9, the controlling method of the battery device 10 according to an embodiment of the present invention may include a first learning step 12, a controlling step 14, a second learning step 16, and a controlling step (14) and the second learning step 16 may be repeated.

### First Learning Step 12

The controller 40 may control to store the training data in the data center 35. The data center 35 may be used interchangeably with the storage unit or the memory 170. The training data may include first input and output data U and first characteristic data Z. The first input and output data U may include at least one of voltage, current, and temperature. The second characteristic data Y may correspond to the first input and output data U. The second characteristic data Y may be characteristic data inside the battery 20.

The Gaussian process neural network 31 may learn using training data stored in a data center. In other words, the Gaussian process neural network 31 may learn to obtain first characteristic data Z corresponding to the first input and output data U which is training data. The obtained first characteristic data Z may be characteristic data Y updated by learning other characteristic data than the first characteristic data Z of the training data but is not limited thereto.

### Controlling Step (14)

The controller 40 may obtain the control value C based on the obtained first characteristic data Z and the user’ usage environment information. The usage environment information may include at least one of, for example, a driving distance per driving, whether to drive at a high speed, an amount of electricity used per hour, and frequency in use of air conditioner or heater. In addition, all conditions or information which may be included in the user's usage environment may also be included in the usage environment information described in the present invention.

The controller 40 may provide the control value C to the object 200. The object 200 may be, for example, the mobile terminal 100 or the electric vehicle 200, but may include a target to which the battery 20 is mounted and operated by a power supply or electric power of the battery 20.

In an embodiment of the invention, the control value C can be obtained using the MPC.

Hereinafter, the MPC is described in detail.

MPC may be an advanced method of process control used to control a process while satisfying a set of constraints. Recently, MPC has been used in power system balancing models. The MPC relies on a dynamic model of the process and may be a linear empirical model obtained mostly through system identification. The main advantage of the MPC is that it is possible to optimize the current time slot, taking into account future time slots. This is accomplished by optimizing a limited time-horizon, but by implementing the current time slot and then optimizing repeatedly the current time slot again, unlike the Linear-Quadratic Regulator (LQR). In addition, MPC has the ability to anticipate future events and has the advantage of taking appropriate action accordingly.

MPC can calculate future changes in dependent variables using current object measurements, the current dynamic state of the process, the MPC model, and process variable goals and limits. These changes can be calculated to keep the dependent variable close to the target while obeying the constraints for both independent and dependent variables. MPC can repeat the calculation when MPC typically sends only the first change of each independent variable to be implemented and the next change is needed.

Since the MPC has been known, it can be easily understood from the known technology, and further description thereof is omitted.

### Secondary Learning Step 16

The object 200 may be operated under the control of the controller 40, that is, according to the control value C from the controller 40, and the battery 20 may be charged or discharged by the operation of the object 200. The collecting unit 30 may collect second input and output data X as the battery 20 is charged or discharged. The second input and output data X may be collected during the battery 20 is being charged or discharged or after the battery 20 is charged or discharged.

The controller 40 may control to update the parameters of the Gaussian process neural network 31 based on the second input and output data X collected by the collecting unit 30. The parameter may include an average value and a variance value, and at least one of the average value and the variance value may be updated.

The Gaussian process neural network 31 may obtain second characteristic data Y corresponding to the second input and output data X based on the updated parameter. The controller 40 may control the second input and output data X and the second characteristic data Y to be stored in the buffer 33. The buffer 33 may be used interchangeably with the memory 170 or the storage unit.

### Repeating Step of the Controlling Step 14 and the Second Learning Step 16.

The control value C is obtained based on the second characteristic data Y and the user's usage environment information, and the battery 20 is charged or discharged as the object 200 is operated according to the control value and thus the second input and output data X can be collected again. By repeating such a process, the second characteristic data Y may be obtained by reflecting the user environment information, so that the second characteristic data Y may be more accurately predicted or followed. As such, the battery 20 may be optimally controlled by charging or discharging the battery 20 based on the second characteristic data Y inside the battery 20 more accurately. Optimum control of the battery 20 can extend the life of the battery 20, it can accurately tell the time to charge the battery 20.

FIG. 10 is a third flowchart illustrating S520 in detail in a controlling method of a battery device according to an embodiment of the present invention.

As illustrated in FIG. 10, the battery device 10 according to the embodiment of the present invention may obtain a state of charge (S621). In other words, the controller 40 may obtain the state of charge based on the first characteristic data Z obtained by the Gaussian process neural network 31. S621 is the same as S611 in FIG. 8.

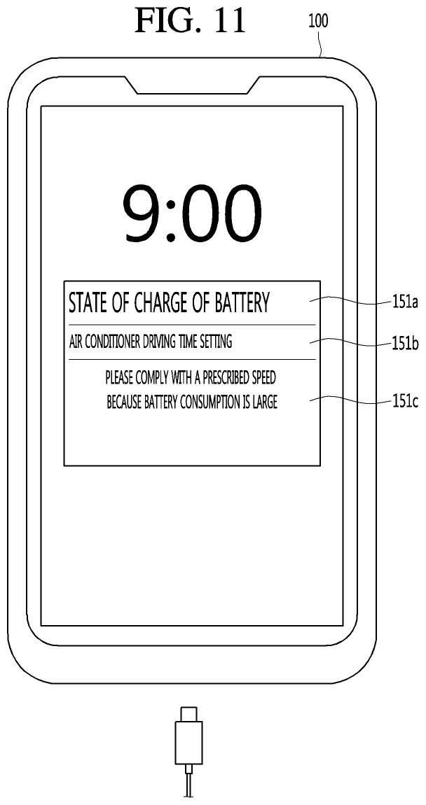

The battery device 10 according to an exemplary embodiment of the present invention may control the display units 151 and 273 to display the state of charge and the corresponding information (S622). As illustrated in FIG. 11, state of charge information 151a of the battery 20 and corresponding information 151b and 151c may be displayed on the display units 151 and 273. The correspondence information may include, for example, air conditioner driving time setting information 151b and guide information 151c such as “Please comply with a prescribed speed because battery consumption is large”. The corresponding information may be information which may affect the charging or discharging of the battery 20.

The battery device 10 according to the embodiment of the present invention may charge or discharge the battery 20 (S623). In other words, the controller 40 may control to charge or discharge the battery according to a command which responds to the corresponding information. For example, upon receiving a command for selecting specific correspondence information from at least one corresponding information displayed on the display units 151 and 273, the controller 40 can control to charge or discharge the battery 20 according to the corresponding selection command.

The above detailed description should not be construed as limiting in all respects but should be considered as illustrative. The scope of the embodiments should be determined by reasonable interpretation of the appended claims, and all changes within the equivalent scope of the embodiments are included in the scope of the embodiments.

What is claimed is:

1. A controlling method of a battery comprising:
learning an artificial neural network to obtain first characteristic data inside the battery corresponding to first input and output data;
collecting second input and output data for a period of time by charging or discharging the battery based on the obtained first characteristic data and user's usage environment information;
updating a parameter of the artificial neural network based on the collected second input and output data; and
learning the artificial neural network to obtain second characteristic data inside the battery corresponding to the collected second input and output data based on the updated parameter.

2. The controlling method of a battery of claim 1,
wherein the artificial neural network is a Gaussian process regression neural network.

3. The controlling method of a battery of claim 1,
wherein the parameter includes at least one of an average value and a variance value.

4. The controlling method of a battery of claim 1,
wherein the first input and output data includes one of training data and the collected second input and output data.

5. The controlling method of a battery of claim 1,
wherein the usage environment information includes at least one of a driving distance per driving, whether to drive at a high speed, an amount of electricity used per hour, and frequency in use of air conditioner or heater.

6. The controlling method of a battery of claim 1,
wherein the first characteristic data and the second characteristic data include at least one of electron conductivity, solid diffusion rate, reaction rate constant of exchange current, torsion degree, porosity, electrolyte concentration, electrolyte conductivity, electrolyte diffusion coefficient, ratio of cation in cation and anion conductivity, the degree of misalignment as the capacity of the positive electrode/negative electrode degenerates, and the degree of decrease in the capacity of the positive electrode/negative electrode.

7. The controlling method of a battery of claim 1, further comprising:
obtaining a control value based on the obtained first characteristic data and usage environment information; and
obtaining the second input and output data by charging or discharging the battery according to the obtained control value.

8. The controlling method of a battery of claim 7,
wherein the control value is obtained using model predictive control (MPC).

9. The controlling method of a battery of claim 1, further comprising:
obtaining a state of charge of the battery based on the first input and output data; and
obtaining the second input and output data by charging or discharging the battery based on the obtained state of charge of the battery and the usage environment information.

10. The controlling method of a battery of claim 9, further comprising:
controlling to display the obtained state of charge of the battery and corresponding information on a display unit; and
controlling to charge or discharge the battery according to a command responsive to the corresponding information.

11. The controlling method of a battery of claim 1, further comprising:
learning to obtain second characteristic data inside the battery corresponding to the collected second input and output data and the first characteristic data.

12. The controlling method of a battery of claim 1,
wherein the first input and output data includes at least one of voltage, current, and temperature.

13. A battery device comprising:
a battery;
a collecting unit configured to collect input and output data of the battery;
an artificial neural network; and
a controller,
wherein the controller is configured:
to control to learn the artificial neural network to obtain first characteristic data inside the battery corresponding to first input and output data,
to control the collection unit to collect second input and output data for a period of time by charging or discharging the battery based on the obtained first characteristic data and user's usage environment information,
to update parameter of the artificial neural network based on the collected second input and output data, and
to control to learn the artificial neural network to obtain second characteristic data inside the battery corresponding to the collected second input and output data based on the updated parameter.

14. The battery device of claim 13,
wherein the artificial neural network is a Gaussian process regression neural network.

15. The battery device of claim 13,
wherein the parameter includes at least one of an average value and a variance value.

16. The battery device of claim 13,
wherein the usage environment information includes at least one of a driving distance per driving, whether to drive at a high speed, an amount of electricity used per hour, and air conditioner or heater use frequency.

17. The battery device of claim 13,
wherein the controller obtains the second input and output data by charging or discharging the battery according to the obtained control value based on the obtained first characteristic data and usage environment information.

18. The battery device of claim 17,
wherein the control value is obtained using model predictive control (MPC).

19. The battery device of claim 13,
wherein the controller obtains a state of charge of the battery based on the first input and output data, and obtains the second input and output data by charging or discharging the battery based on the obtained state of charge of the battery and the usage environment information.

20. The battery device of claim 19, further comprising:
a display,
wherein the controller controls to display the obtained state of charge of the battery and corresponding information on the display unit; and controls to charge or discharge the battery according to a command responsive to the corresponding information.
